(19) United States
(12) Patent Application Publication
(10) Pub. No.: US 2007/0064188 A1
(43) Pub. Date: Mar. 22, 2007

(54) Liquid crystal display panel and method for manufacturing the same

(75) Inventor: Mamoru Okamoto, Kanagawa (JP)

Correspondence Address: YOUNG & THOMPSON, 745 SOUTH 23RD STREET, 2ND FLOOR, ARLINGTON, VA, 22202, US

(73) Assignee: NEC LCD TECHNOLOGIES, LTD., KANAGAWA (JP)

(21) Appl. No.: 11/472,398

(22) Filed: Jun. 22, 2006

(30) Foreign Application Priority Data
Jun. 22, 2005 (JP) 2005-181550

(51) Int. Cl. G02F 1/141; G02F 1/1343

(52) U.S. Cl. 349/135; 349/140

(57) ABSTRACT

An alignment mark is provided on the surface of a transparent substrate in a CF substrate. An L-shaped pattern whose height is greater than that of the alignment mark is provided in a position that is at a distance upstream in the rubbing direction as viewed from the alignment mark. The trapping pattern is formed by the layering of a lower layer BM and an upper layer B. The lower layer BM of the alignment mark and the trapping pattern is formed from the same material and in the same step as the black matrix. The upper layer B of the trapping pattern is formed from the same material and in the same step as the blue color filter. Debris from the alignment layer can thereby be prevented from accumulating in the region adjacent to the alignment mark when a rubbing treatment is performed on the alignment layer.

### BACKGROUND OF THE INVENTION

1. Field of the Invention

The present invention relates to a liquid crystal display panel and to a method for manufacturing the same.

2. Description of the Related Art

A liquid crystal display (LCD) device is provided with a light source and a LCD panel, and the LCD panel is provided with two transparent substrates arranged parallel to each other, and a liquid crystal layer disposed between the transparent substrates. In the LCD device, the LCD panel is irradiated with light from the light source, and images are displayed by applying a voltage to the liquid crystal layer of the LCD panel and controlling the transmittance of the light.

Among the two transparent substrates of the LCD panel, one of the transparent substrates is referred to as a Thin Film Transistor (TFT) substrate, and the other transparent substrate is referred to as a color filter (CF) substrate. A plurality of pixel electrodes for applying a voltage to the liquid crystal layer are provided to the TFT substrate and are arranged in a matrix. The TFT comprises a gate electrode, a semiconductor layer, a drain electrode, and a source electrode. A black matrix, color filter layers and a counter electrode for applying a voltage to the liquid crystal layer are provided on the CF substrate.

An alignment layer is formed on the surface of the TFT substrate that faces the CF substrate, and on the surface of the CF substrate that faces the TFT substrate. A rubbing treatment is performed on the surface of the alignment layers so as to give the liquid crystal molecules of the liquid crystal layer a pre-tilt angle. A seal member is also provided so as to surround the display region between the TFT substrate and the CF substrate, the area inside of this seal member is filled with liquid crystals, and the liquid crystal layer is formed. A plurality of spacers are disposed between the TFT substrate and the CF substrate. Polarizers are bonded to opposite side of the surface of the TFT substrate to the CF substrate, and bonded to opposite side of the surface of the CF substrate to the TFT substrate (see Japanese Laid-open Patent Application No. 11-337948, for example).

An alignment mark that serves as an alignment reference when the TFT substrate and the CF substrate are bonded each other in the LCD panel manufacturing process is also formed in the area outside of the display region on the surface of the CF substrate that faces the TFT substrate. The alignment mark is composed of the same material as the black matrix, for example, and is formed in the same step as the black matrix (see Japanese Laid-open Patent Application No. 8-6005, for example). Alignment of the TFT substrate with the CF substrate is performed by an automatic matching measurement system. The automatic matching measurement system detects the position of the alignment mark by illuminating the area around the alignment mark on the CF substrate with white light, receiving the reflected light to create an image of the area around the alignment mark, and digitizing this image.

However, the conventional technique described above has such problems as described below. Since the alignment mark provided on the CF substrate is formed from the same material and in the same step as the black matrix, the alignment mark has the same film thickness as the black matrix. Specifically, when the black matrix has a film thickness of 1.2 μm, for example, the film thickness of the alignment mark is also 1.2 μm. In this case, the edge of the alignment mark forms a step 1.2 μm high. When a rubbing treatment is applied to the alignment layer of the CF substrate, the surface layer of the alignment layer is torn down, which results in causing debris from the alignment layer that moves in the rubbing direction. Most part of the debris from the alignment layer are concentrated at the step portion on the alignment mark as described above.

FIG. 1 is a plan view showing the area around the alignment mark on the CF substrate after a rubbing treatment. The rubbing direction 100 is also indicated in FIG. 1 for the sake of convenience. As shown in FIG. 1, an alignment mark 102 patterned in a rectangular shape is provided on the CF substrate 101. Debris 103 from the alignment layer are deposited on the upstream side of the rubbing direction 100 as viewed from the alignment mark 102.

When debris from the alignment layer is thus deposited in the region adjacent to the alignment mark, the automatic matching measurement system cannot correctly distinguish between the light reflected by the alignment mark and the light reflected by the debris from the alignment layer when the device is detecting the alignment mark. The edge of the alignment mark cannot be clearly identified even when the image thus acquired is digitized, and the position of the alignment mark cannot, be properly detected. As a result, an error occurs in the recognition of the alignment mark. When this type of recognition error occurs, it is difficult to put the TFT substrate upon the CF substrate together accurately. The black matrix provided on the CF substrate thereby becomes misaligned with respect to the drain electrode and gate electrode provided on the TFT substrate and this misalignment causes light leakage from the backlight. As a result, characteristics of the TFT suffer due to intrusion of the light leakage into the semiconductor layer of the TFT. Among the equipment for fabricating a LCD panel, the automatic matching measurement system is the item of equipment in which the highest level of precision is required. However, when debris from the alignment layer is deposited in the region adjacent to the alignment mark as described above, no degree of enhancement in the performance of the automatic matching measurement system can enable alignment to be performed with adequate precision.

### SUMMARY OF THE INVENTION

An object of the present invention is to provide a LCD whereby debris from the alignment layer can be prevented from accumulating in the region adjacent to the alignment mark after rubbing to the alignment layer, and to provide a method for manufacturing the same.

The LCD according to the present invention has a first substrate, a second substrate disposed facing the first substrate, and a liquid crystal layer disposed between the first substrate and the second substrate, wherein the first substrate has an alignment mark for performing alignment with respect to the second substrate, and debris from the alignment layer is not deposited in the region adjacent to the alignment mark.

In the present invention, since debris from the alignment layer is not deposited in the region adjacent to the alignment mark, the first substrate and the second substrate can be aligned with each other with high precision.

The LCD according to another aspect of the present invention has a first substrate, a second substrate disposed. facing the first substrate, and a liquid crystal layer disposed between the first substrate and the second substrate, wherein the first substrate has an insulating substrate, an alignment layer which is provided on the insulating substrate and which imparts a pre-tilt angle to the liquid crystal molecules of the liquid crystal layer, an alignment mark for alignment with respect to the second substrate and which is provided on the insulating substrate; and a trapping pattern having greater step than the step of the alignment mark and being provided in a position, at least upstream in the rubbing direction of the alignment layer.

In the present invention, the term “trapping pattern” refers to a wall-shaped protrusion.

In the present invention, since debris from the alignment layer is trapped by the trapping pattern after a rubbing treatment is performed on the alignment layer, debris can be prevented from accumulating in the region adjacent to the alignment mark.

The trapping pattern may be L-shaped as viewed from the surface of the insulating substrate. Alternatively, the trapping pattern may be in the shape of a frame that surrounds the alignment mark as viewed from the surface of the insulating substrate. Debris can thereby be prevented from accumulating in the region adjacent to the alignment mark regardless of the rubbing direction.

The LCD according to another aspect of the present invention has a first substrate, a second substrate disposed facing the first substrate, and a liquid crystal layer disposed between the first substrate and the second substrate, wherein the first substrate has an insulating substrate, an alignment layer which is provided on the insulating substrate and which imparts a pre-tilt angle to the liquid crystal molecules of the liquid crystal layer, and an alignment mark whereby alignment is performed with respect to the second substrate and which is provided on the insulating substrate; and the angle between the surface of the insulating substrate and the lateral surface of the alignment mark is 30 to 60 degrees.

In the present invention, since the angle between the surface of the insulating substrate and the lateral face of the alignment mark is 30 to 60 degrees, it is possible to reduce trapping of debris at the edge of the alignment mark.

The LCD according to another aspect of the present invention has a first substrate, a second substrate disposed facing the first substrate, and a liquid crystal layer disposed between the first substrate and the second substrate, wherein the first substrate has an insulating substrate, an alignment layer which imparts a pre-tilt angle to the liquid crystal molecules of the liquid crystal layer and which is provided on the insulating substrate, and an alignment mark whereby alignment is performed with respect to the second substrate and which is provided on the insulating substrate; and the alignment mark is covered by the alignment layer.

In the present invention, since the alignment mark is covered by the alignment layer, the edge of the alignment mark has a gentle slope, and trapping of debris at the edge of the alignment mark can be reduced.

The method for manufacturing a LCD according to the present invention comprises the steps of: bonding a first substrate and a second substrate together and inserting a liquid crystal layer between said substrates; further comprising the steps of forming an alignment mark and a trapping pattern on an insulating substrate, whose step is greater than the step of the alignment mark, forming an alignment layer for imparting a pre-tilt angle to the liquid crystal molecules of the liquid crystal layer on the insulating substrate, and performing a rubbing treatment on the alignment layer in the direction from the trapping pattern to the alignment mark; and the bonding is performed by using the alignment mark.

In the present invention, a trapping pattern is formed, and the debris from the alignment layer is trapped by the trapping pattern by performing the rubbing treatment along the direction from the trapping pattern to the alignment mark. Therefore, the debris can be prevented from accumulating in the region adjacent to the alignment mark.

The step for forming an alignment mark and a trapping pattern preferably comprises the steps of forming an opaque resin layer; patterning and baking the resin layer to form a black matrix, the lower layer of the alignment mark, and the lower layer of the trapping pattern; forming a colored transparent resin layer; and patterning the transparent resin layer and forming the upper layer of the trapping pattern and a color filter. Since the alignment mark and the trapping pattern can thereby be formed using the step in which the black matrix and the color filter are formed, there is no need to provide a special step for forming the trapping pattern.

The method for manufacturing a LCD according to another aspect of the present invention comprises: bonding a first substrate and a second substrate together; inserting a liquid crystal layer between said substrates, further comprising a step for forming an opaque resin layer on an insulating substrate, a step for patterning the resin layer, a first heating step for heating the patterned resin layer at a first temperature for a first period, a second heating step for heating the resin layer for a second period longer than said first period and at a second temperature higher than the first temperature and forming an alignment mark lateral surface whose angle is 30 to 60 degrees with respect to the surface of said insulating substrate, a step for forming an alignment layer to impart a pre-tilt angle to the liquid crystal molecules of the liquid crystal layer on the insulating substrate, and a step for performing a rubbing treatment on the alignment layer, and wherein the bonding is performed by using the alignment mark.

The method for manufacturing a LCD according to still another aspect of the present invention comprises the steps of: bonding a first substrate and a second substrate together; inserting a liquid crystal layer between said substrates, further comprising a step for forming an alignment mark on an insulating substrate, a step for forming an alignment layer to impart a pre-tilt angle to the liquid crystal molecules of the liquid crystal layer on the insulating substrate so as to cover the alignment mark, and a step for performing a rubbing treatment on the alignment layer, and wherein the bonding is performed by using the alignment mark.

According to the present invention, debris from the alignment layer can be prevented from accumulating in the region adjacent to the alignment mark when the alignment layer in the LCD is subjected to a rubbing treatment. Alignment between the substrates can thereby be performed with high precision and without errors in alignment mark detection.

### BRIEF DESCRIPTION OF THE DRAWINGS

FIG. 1 is a tracing of a photograph taken through an optical microscope showing the area around the alignment mark on the CF substrate after a rubbing treatment has been performed;

FIG. 2 is a sectional view showing the LCD according to a first embodiment of the present invention;

FIG. 3 is a plan view showing the CF substrate of the LCD shown in FIG. 2;

FIG. 4 is a plan view showing the alignment mark and the trapping pattern of the CF substrate shown in FIG. 3;

FIG. 5 is a sectional view along line A-A′ shown in FIG. 3;

FIG. 6 is a perspective view showing the alignment mark and trapping pattern shown in FIG. 4;

FIG. 7 is a plan view showing the operation of the LCD according to the present embodiment, in which the alignment mark and the trapping pattern are shown;

FIG. 8 is a plan view showing the alignment mark and trapping pattern of the CF substrate in a modification of the first embodiment;

FIG. 9A is a plan view showing the alignment mark in the LCD according to a second embodiment of the present invention, and FIG. 9B is a sectional view along line B-B′ shown in FIG. 9A; and

FIGS. 10A and 10B are tracings of SEM photographs showing the alignment mark, wherein FIG. 10A shows the results of baking under the conditions described in the fourth embodiment, and FIG. 10B shows the results of baking under the conditions described in the fifth embodiment.

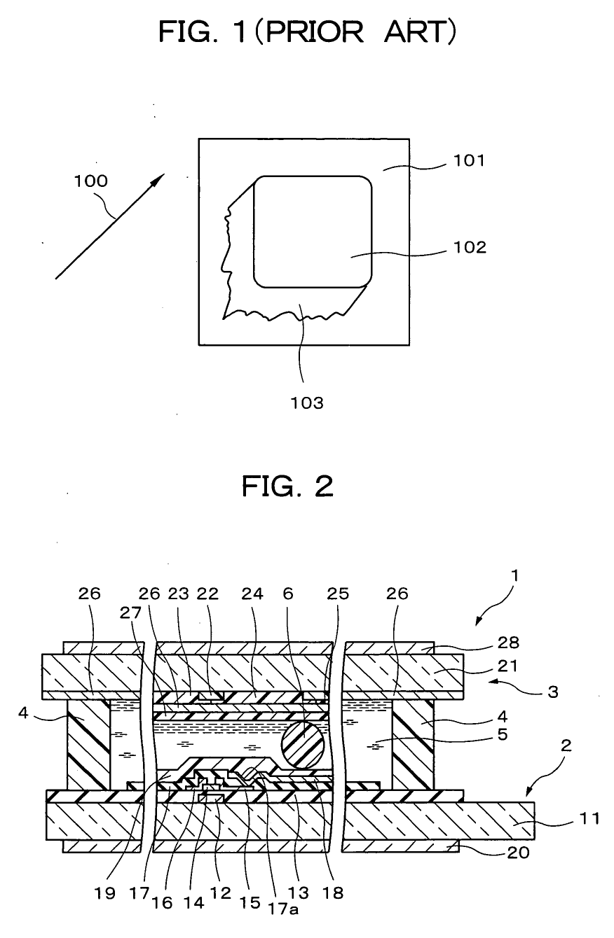

### DESCRIPTION OF THE PREFERRED EMBODIMENTS

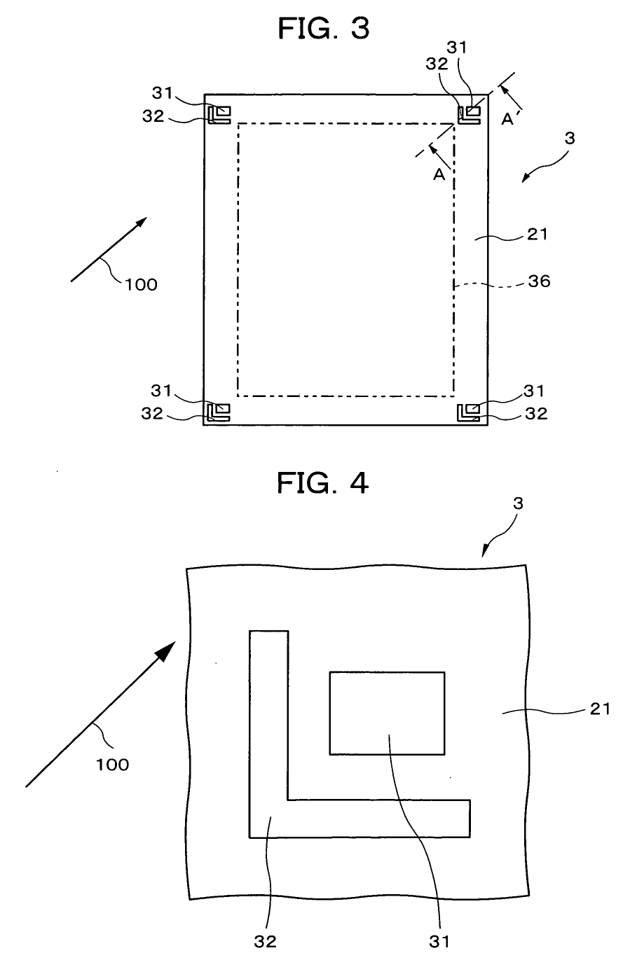

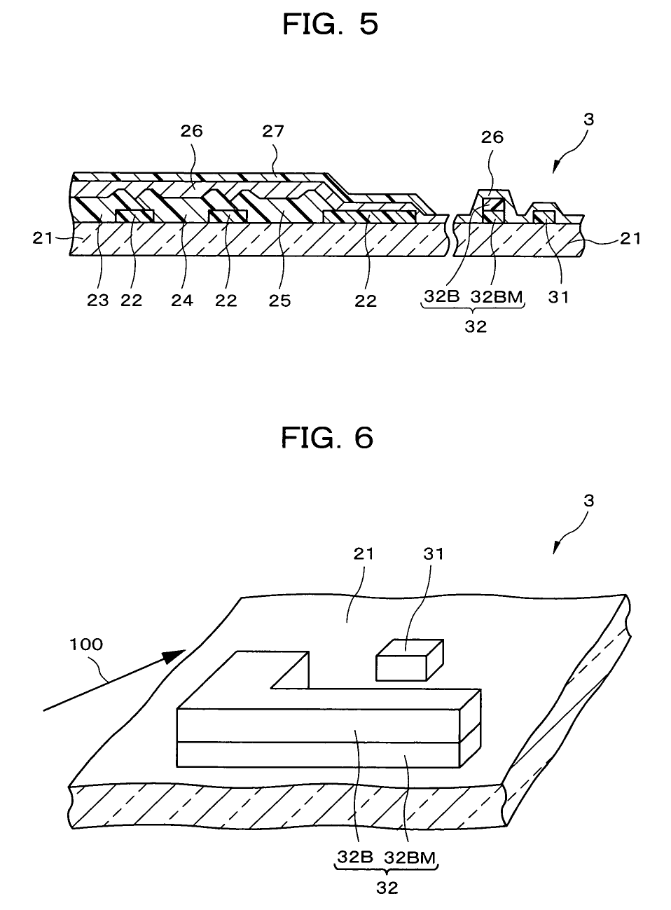

Embodiments of the present invention will be described in detail hereinafter with reference to the accompanying drawings. A first embodiment of the present invention will first be described. FIG. 2 is a sectional view showing the LCD according to the present embodiment; FIG. 3 is a plan view showing the CF substrate of this LCD; FIG. 4 is a plan view showing the alignment mark and the trapping pattern of the CF substrate shown in FIG. 3; FIG. 5 is a sectional view along line A-A′ shown in FIG. 3; and FIG. 6 is a perspective view showing the alignment mark and trapping pattern shown in FIG. 4.

In the LCD panel 1 according to the present embodiment as shown in FIG. 2, a TFT substrate 2 and a color filter (CF) substrate 3 are provided parallel to each other, and a frame-shaped seal member 4 is provided between the TFT substrate 2 and the CF substrate 3 so as to surround the display region of the LCD panel 1. Liquid crystal is filled into the inside of the seal member 4, and a liquid crystal layer 5 is formed. A plurality of spacers 6 are disposed in the liquid crystal layer 5. The spacers 6 maintain a constant distance between the TFT substrate 2 and the CF substrate 3.

A transparent substrate 11 is provided to the TFT substrate 2. The transparent substrate 11 is composed of non-alkali glass or another transparent insulating material. A plurality of gate electrodes 12 extending in one direction are provided parallel to each other on the surface of the transparent substrate 11 that faces the CF substrate 3. The gate electrodes 12 are formed from metal such as aluminum. A gate insulating film 13 is also provided on the transparent substrate 11 so as to cover the gate electrodes 12. The gate insulating film 13 is composed of silicon nitride.

A semiconductor layer 14 is provided in localized fashion to the regions that include the areas directly above the gate electrodes 12 on the gate insulating film 13. The semiconductor layer 14 is composed of amorphous silicon. An impurity is implanted into the semiconductor layer 14, and the semiconductor layer 14 is divided into a source region, a drain region, and a channel region (not shown in the drawing) between the source region and the drain region according to the type and concentration of the impurity. On the gate insulating film 13, a source electrode 15 is provided so as to be connected to the source region of the semiconductor layer 14, and a drain electrode 16 is provided so as to be connected to the drain region. The source electrode 15 and the drain electrode 16 are composed of metal such as Al.

Furthermore, a passivation film 17 is provided on the gate insulating film 13 so as to cover the semiconductor layer 14, the source electrode 15, and drain electrode 16. The passivation film 17 is composed of silicon nitride. Besides silicon nitride or another inorganic material, the passivation film 17 may also be formed from an epoxy-based resin, an acrylic-based resin, or another transparent resin material. A contact hole 17a such as one that leads to the source electrode 15 is formed in the passivation film 17.

A pixel electrode 18 is provided in the region that includes the area directly above the contact hole 17a on the passivation film 17. The pixel electrode 18 is a transparent conductive film composed of ITO (Indium Tin Oxide), and is connected to the source electrode 15 via the contact hole 17a.

An alignment layer 19 is provided on the passivation film 17 so as to cover the pixel electrode 18. The alignment layer 19 is composed of a polyimide-based resin material and the surface thereof is rubbed in one direction. A polarizer 20 is also affixed to the surface of the opposite side of the transparent substrate 11 to CF substrate 3.

A transparent substrate 21 is provided to the CF substrate 3. The transparent substrate 21 is composed of non-alkali glass. On the surface of the side of the transparent substrate 21 that faces the TFT substrate 2, a black matrix (BM) 22 is provided to the region that faces the gate electrodes 12 of the TFT substrate 2. The width of the black matrix 22 is made a size larger than the width of the gate electrodes 12 in order to prevent light leakage and to reliably shield the semiconductor layer 14 of the TFT substrate 2 from light. The black matrix 22 is composed of an opaque resin material (a black-colored resin material, for example) and has a film thickness of 1 to 3 μm, for example (1.2 μm, for example). The black matrix 22 preferably has an optical density (OD value: Optical Density) of 3 or higher, and the film thickness thereof is preferably as small as possible.

A red color filter 23, a green color filter 24, and a blue color filter 25 are provided to each of the regions made up of the spaces in the black matrix 22 on the transparent substrate 21. Each color filter is composed of a transparent resin that is colored with the filter's respective color, and has a film thickness of 1.0 to 1.5 μm, for example (1.3 μm, for example). The red color filter 23, green color filter 24, and blue color filter 25 are repeatedly arranged in this sequence in the direction orthogonal to the extension direction of the gate electrodes 12 and black matrix 22. The ends of the color filters are superposed on the ends of the black matrix 22.

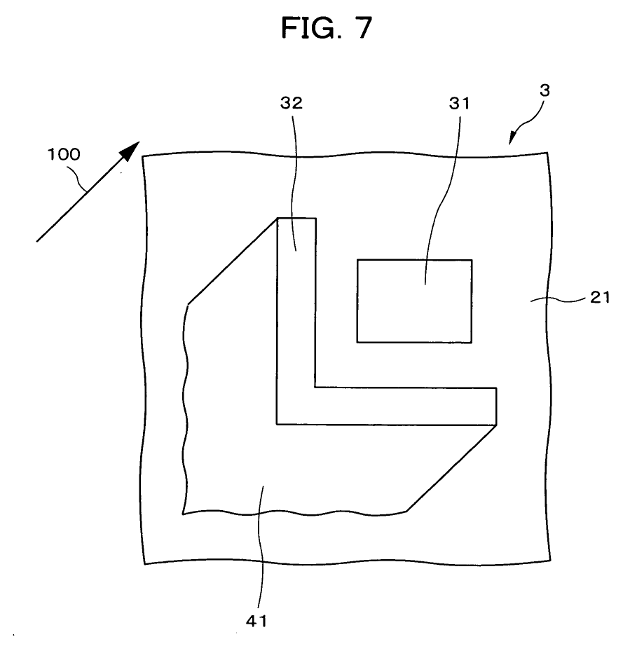

A counter electrode 26 composed of ITO is furthermore provided over the entire surface of the transparent substrate 21. In FIGS. 3, 4, and 6, the counter electrode is omitted in order to simplify the drawing. This is also the case in FIGS. 7 through 9 described hereinafter. An alignment layer 27 is furthermore provided on the entire surface of the counter electrode 26. The alignment layer 27 is composed of a polyimide-based resin material, for example, and has a film thickness of 100 to 200 nm. The surface thereof is rubbed in one direction. The counter electrode 26 and the alignment layer 27 are not provided to the outside of the display region of the CF substrate 3. A polarizer 28 is furthermore affixed to the surface of the side of the transparent substrate 21 to the TFT substrate 2.

As shown in FIG. 3, an alignment mark 31 is provided to the outside of the display region 36 on the surface of the transparent substrate 21. A total of four alignment marks 31, one at each corner, are provided to the transparent substrate 21. The alignment mark 31 is composed of the same material and is formed in the same step as the black matrix 22. Specifically, the alignment mark 31 is composed of a black-colored resin material and has a film thickness of 1 to 3 μm, for example (1.2 μm, for example). The alignment mark 31 is rectangular, for example, as viewed from the direction perpendicular to the surface of the transparent substrate 21 (hereinafter, “as viewed from above”).

As shown in FIGS. 3 and 4, the rubbing direction 100 with respect to the alignment layer 27 of the CF substrate 3 is angled with respect to the edges of the transparent substrate 21. A trapping pattern 32 is provided at a distance from the alignment mark 31 on the upstream side of the rubbing direction 100, i.e., on the side in the forward direction of rubbing, as viewed from the alignment mark 31. The trapping pattern 32 is disposed on the outside of the display region 36. The trapping pattern 32 is composed of two linear portions that are orthogonal to each other, and is L-shaped overall. The linear portions of the trapping pattern 32 also face and are disposed parallel to the two edges of the alignment mark 31 that are on the upstream side of the rubbing direction 100.

As shown in FIGS. 5 and 6, the trapping pattern 32 is a two-layer film composed of a lower layer 32BM and an upper layer 32B. The lower layer 32BM is formed from the same material and in the same step as the black matrix 22 and the alignment mark 31. Specifically, the lower layer 32BM is composed of a black-colored resin material and has a film thickness of 1 to 3 μm, for example (1.2 μm, for example). The upper layer 32B is formed from the same material and in the same step as the blue color filter 25. Specifically, the upper layer 32B is composed of a blue-colored transparent resin and has a film thickness of 1.0 to 1.5 μm, for example (1.3 μm, for example). The lower layer 32BM thus has a film thickness of 1.2 μm, for example, and the upper layer 32B has a film thickness of 1.3 μm, for example. Therefore, the trapping pattern 32 has a film thickness of 2.5 μm, for example, and is thicker than the alignment mark 31, which has a film thickness of 1.2 μm, for example.

The operation of the LCD according to the present embodiment thus configured will next be described. FIG. 7 is a plan view showing the operation of the LCD according to the present embodiment, in which the alignment mark and the trapping pattern are shown in FIG. 7, the surface layer of the alignment layer 27 in the present embodiment is scraped, and debris 41 is generated when the alignment layer 27 provided to the outermost surface of the CF substrate 3 is subjected to a rubbing treatment during manufacturing of the LCD panel 1 (see FIG. 2). When this debris 41 moves in the rubbing direction 100 in conjunction with the rubbing treatment and reach the trapping pattern 32, the debris 41 is trapped by the trapping pattern 32. The debris 41 is deposited on the upstream side of the rubbing direction of the trapping pattern 32. At this time, even though the alignment mark 31 is provided to the downstream side of the rubbing direction 100 of the trapping pattern 32, the height of the alignment mark 31 is less than that of the trapping pattern 32, and the debris 41 is therefore not deposited on the periphery of the alignment mark 31.

The effect of the present embodiment will next be described. As described above, in the LCD panel 1 according to the present embodiment, debris 41 is not deposited on the periphery of the alignment mark 31. Therefore, errors in alignment recognition do not occur when the automatic matching measurement system detects the alignment mark 31 during bonding of the TFT substrate 2 to the CF substrate 3. The TFT substrate 2 and the CF substrate 3 can therefore be efficiently aligned with each other with high precision.

An example is described in the present embodiment in which the shape of the alignment mark 31 is rectangular as viewed from above, but the shape of the alignment mark is determined by the specifications of the automatic matching measurement system used in the panel assembly step, and is not limited to being rectangular. Specifically, the alignment mark 31 may have a round shape, a dot-type shape, or another shape.

An example is also described in the present embodiment in which the upper layer 32B of the trapping pattern 32 is formed from the same material and in the same step as the blue color filter 25, but the present embodiment does not limit this configuration, and the upper layer 32B may be formed from the same material and in the same step as the red color filter 23 or the green color filter 24.

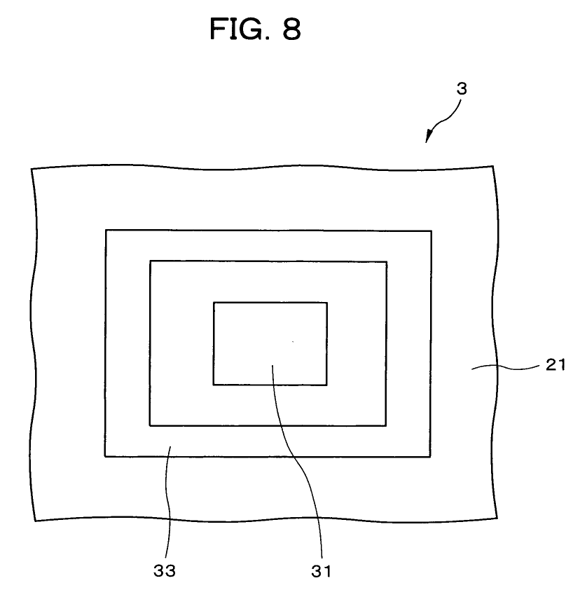

A modification of this first embodiment will next be described. FIG. 8 is a plan view showing the alignment mark and trapping pattern of the CF substrate in the present modification. As shown in FIG. 8, a frame-shaped trapping pattern 33 is formed so as to surround the alignment mark 31 on the transparent substrate 21 of the CF substrate 3 in the present modification. The lower layer of this trapping pattern 33 is formed from the same material as the black matrix, and the upper layer is formed from the same material as the blue color filter. According to the present modification, regardless of the rubbing direction, the positioning of any portion of the trapping pattern 33 on the upstream side of the rubbing direction of the alignment mark 31 makes it possible to prevent debris 41 from accumulating on the periphery of the alignment mark 31. Configurations, operations, and effects other than those described above in the present modification are the same as in the previously described first embodiment.

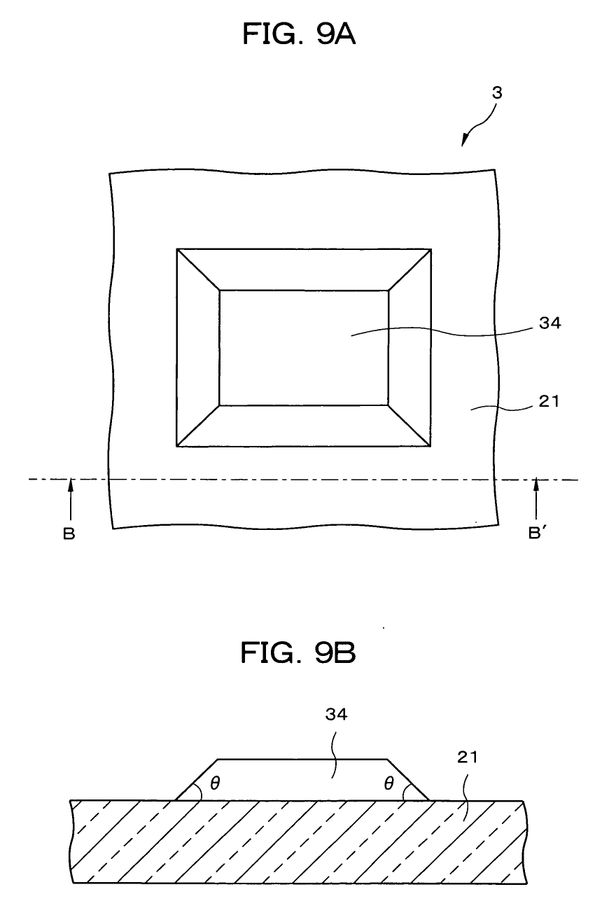

A second embodiment of the present invention will next be described. FIG. 9A is a plan view showing the alignment mark in the LCD according to the present embodiment, and FIG. 9B is a sectional view along line B-B′ shown in FIG. 9A. As shown in FIGS. 9A and 9B, the LCD according to the present embodiment differs from the previously described first embodiment in that an alignment mark 34 is provided instead of the alignment mark 31 (see FIG. 4) in the CF substrate, and the trapping pattern 32 (see FIG. 4) is not provided. The alignment mark 34 is in the shape of a square truncated pyramid, and the angle 6 (hereinafter referred to as the taper angle) between the transparent substrate 21 and the lateral face of the alignment mark 34 is 30 to 60 degrees (45 degrees, for example). Other aspects of the configuration of the present embodiment are the same as in the previously described first embodiment.

Reasons for limiting the numerical values in the specifications of the present invention will next be described. Specifically, the reason for making the taper angle of the alignment mark 30 to 60 degrees will be described. When the taper angle of the alignment mark 34 is less than 30 degrees, minute patterns become difficult to form, and it becomes impossible to form the alignment mark 34 and the black matrix on a microscopic scale. When the taper angle exceeds 60 degrees, debris from the alignment layer becomes more likely to accumulate. The taper angle of the alignment mark 34 is therefore set to from 30 to 60 degrees.

The operation of the present embodiment will next be described. In the present embodiment, since the taper angle of the alignment mark 34 is 30 to 60 degrees (45 degrees, for example), the debris 41 from the alignment layer are less likely to be trapped at the edge of the alignment mark 34, and are less likely to accumulate in the region adjacent to the alignment mark 34 when the alignment layer 27 (see FIG. 2) of the CF substrate 3 is subjected to the rubbing treatment. Alignment recognition errors can thereby be prevented from occurring when alignment is performed using the automatic matching measurement system. Operations and effects other than those described above in the present embodiment are the same as in the previously described first embodiment.

A third embodiment of the present invention will next be described. Compared to the previously described first embodiment, the region in which the alignment layer 27 (see FIG. 2) is formed is extended outward about 1 to 2 mm in the LCD configured according to the present embodiment. As a result, the alignment mark 31 (see FIG. 3) is covered by the alignment layer 27. The trapping pattern 32 (see FIG. 4) is also not provided. Aspects of the configuration of the present embodiment other than those described above are the same as in the previously described first embodiment.

In the present embodiment, the alignment mark having a film thickness of 1 to 3 μm, for example (1.2 μm, for example), is covered by the alignment layer having a film thickness of 100 to 200 nm, for example. The stepped portion at the edge of the alignment mark can thereby be given a gentle slope. The edge effect in this step portion during the rubbing treatment of the alignment layer is thereby diminished, and frictional resistance can be reduced. As a result, trapping of debris from the alignment layer by this stepped portion can be suppressed, and the debris can be prevented from accumulating around the alignment mark. Alignment recognition errors in the automatic matching measurement system are thereby made less likely to occur.

Two or more embodiments among the first through third embodiments described above may be combined and implemented. For example, the taper angle of the alignment mark may be set to 30 to 60 degrees as in the previously described second embodiment, the trapping pattern may be formed on the upstream side of the rubbing direction of the alignment mark as in the previously described first embodiment, and the alignment mark may be covered by the alignment layer. This configuration makes it even less likely for debris from the alignment layer to be deposited around the alignment mark.

A fourth embodiment of the present invention will next be described. The present embodiment is an embodiment of the method for manufacturing the LCD panel according to the previously described first embodiment. The following description will be given with reference to FIGS. 2 through 7. The method for creating the TFT substrate 2 will first be described. As shown in FIG. 2, a glass substrate having a sheet thickness of, for example, 0.7 mm composed of non-alkali glass or another transparent insulating material is prepared as the transparent substrate 11. Al is then deposited onto one surface of the transparent substrate 11. This film is then patterned to a plurality of gate electrodes 12.

An insulating film is composed of a silicon nitride is then formed on the entire surface of the transparent substrate 11 and a gate insulating film 13 is formed so as to cover the gate electrodes 12. A layer of amorphous silicon is then formed on this gate insulating film 13, this amorphous silicon layer is patterned, and a semiconductor layer 14 is formed in the regions that include the areas directly above the gate electrodes 12. A source region, a channel region, and a drain region are formed by selectively introducing impurities into this semiconductor layer 14.

A conductive film is then formed on the gate insulating film 13 and a pattern is formed thereon by a photolithography method. A source electrode 15 connected to the source region of the semiconductor layer 14 is thereby formed, and a drain electrode 16 connected to the drain region is also formed. An insulating film composed of a silicon nitride is then formed on the gate insulating film 13 so as to cover the semiconductor layer 14, the source electrode 15, and the drain electrode 16, and a passivation film 17 is formed. At this time, a contact hole 17a is formed in the passivation film 17 in a portion of the area directly above the source electrode 15 so as to reach the source electrode 15.

A transparent conductive film composed of ITO is then patterned and a pixel electrode 18 is formed. The pixel electrode 18 is also formed on the inside surface of the contact hole 17a so as to be connected to the source electrode 15 via the contact hole 17a. An alignment layer 19 is then formed on the passivation film 17 so as to cover the pixel electrode 18. The surface of the alignment layer 19 is also subjected to a rubbing treatment in one direction using a rubbing roller in which cotton, rayon, or other fibers are wound around a core member. The TFT substrate 2 is thereby created.

The method for forming the CF substrate 3 will next be described. As shown in FIG. 2, a glass substrate is first prepared as the transparent substrate 21. One of the surfaces of this transparent substrate 21 is then coated with a negative photosensitive acrylic resist (for example, an OPTMER CR series, manufactured by JSR Corporation) in which a light-blocking pigment is dispersed, or is coated with a carbon-based resist material or other black-colored resin material; a light-blocking resin layer is formed; and this resin layer is exposed to light and developed, whereby a pattern is formed in the desired shape. The film thickness of this resin layer at this time is 1 to 3 μm, for example (1.2 μm, for example). Baking is then performed in a clean oven at a temperature of 230° C. for 60 minutes, for example, and the resin layer is cured.

The black matrix 22, the alignment mark 31, and the lower layer 32BM of the trapping pattern 32 are thereby formed. At this time, the black matrix 22 is formed inside the display region 36, and will be formed in the positions opposite the gate electrodes 12 in a subsequent step when the CF substrate 3 is bonded to the TFT substrate 2. Specifically, the black matrix 22 is formed as a plurality of strips that extend parallel to each other. However, in order to prevent light leakage and to reliably shield the semiconductor layer 14 from light, the width of the black matrix 22 is made a size larger than that of the gate electrodes 12. The film thickness of the black matrix 22 is preferably made as small as possible while maintaining an optical density (OD value) of 3 or higher.

As shown in FIGS. 3 and 4, the alignment mark 31 and the lower layer 32BM of the trapping pattern 32 are formed at each of the four corners of the transparent substrate 21. The shape of the alignment mark 31 is rectangular, for example, as viewed from above. The lower layer 32BM of the trapping pattern 32 is also formed so as to be L-shaped as viewed from above, and is formed at a distance from the alignment mark 31 on the upstream side of the rubbing direction 100 in which the alignment layer 27 is rubbed in a subsequent step as viewed from the alignment mark 31. Specifically, the two linear portions constituting the lower layer 32BM face the two edges of the alignment mark 31 on the upstream side of the rubbing direction 100, and are parallel to these edges.

A red color filter 23 is then formed in every third region in the regions included in the black matrix 22 on the transparent substrate 21, as shown in FIGS. 2 and 5. For example, a negative photosensitive color resist (for example, an OPTMER CR series, manufactured by JSR Corporation) in which a red pigment is dispersed in an acrylic-based resin, or another red-colored transparent resin is applied to the substrate using a spin coating method. The spinning speed is adjusted at this time to give a post-baking film thickness of 1.0 to 1.5 μm, for example. Pre-baking is then performed using a hot plate at a temperature of 80° C. and a time of two minutes, for example, and light exposure is performed, after which a pattern is formed by development in TMAH (Tetra Methyl Ammonium Hydroxide) developing fluid. Baking is then performed in a clean oven at a temperature of 230° C. for 60 minutes, for example, and the red-colored transparent resin layer is cured. The red color filter 23 is thereby formed.

By applying, pre-baking, exposing to light, developing, and baking a green-colored transparent resin on the transparent substrate 21 in accordance with the same method, a green color filter 24 is formed in those regions of the black matrix 22 on the transparent substrate 21 in which the red color filter 23 is formed. By applying, pre-baking, exposing to light, developing, and baking a blue-colored transparent resin on the transparent substrate 21 in accordance with the same method, a blue color filter 25 is formed in those regions of the region in which the red color filter 23 and green color filter 24 are not formed. The red color filter 23, the green color filter 24, and the blue color filter 25 are thereby arranged in this sequence so as to repeat in the direction orthogonal to the extension direction of the black matrix 22.

The blue-colored transparent resin is also allowed to remain at this time in the area directly above the lower layer 32BM of the trapping pattern 32, and the upper layer 32B is formed. The trapping pattern 32 is thereby formed. Since the film thickness of the lower layer 32BM is the same as that of the black matrix 22 (1.2 μm, for example), and the film thickness of the upper layer 32B is the same as that of the blue color filter 25 (1.3 μm, for example), the film thickness of the trapping pattern 32 as a whole is 2.5 μm, for example.

A transparent conductive film is then formed on the entire surface of the transparent substrate 21 so as to cover the black matrix 22, the red color filter 23, the green color filter 24, and the blue color filter 25. Since no patterning is required for this ITO film, a counter electrode 26 is thereby formed.

The alignment layer 27 is then formed on the counter electrode 26 as shown in FIG. 2. As shown in FIG. 4, the surface of this alignment layer 27 is subjected to a rubbing treatment along the rubbing direction 100 using a rubbing roller in which cotton, rayon, or other fibers are wound around a core member. The trapping pattern 32 having a height that is greater than that of the alignment mark 31 is provided at this time on the upstream side of the rubbing direction 100 as viewed from the alignment mark 31, as shown in FIGS. 6 and 7. Therefore, the debris 41 from the alignment layer 27 that forms in conjunction with the rubbing treatment are trapped on the upstream side of the trapping pattern 32, and are not deposited around the alignment mark 31. The CF substrate 3 is created according to the process described above.

The seal member 4 is then formed so as to surround the display region 36 (see FIG. 3) on the surface of the CF substrate 3 on the side on which the color filter is formed, as shown in FIG. 2. Liquid crystal is filled into the region enclosed by the seal member 4 using an ODF method (One Drop Fill method: liquid crystal drop bonding method). A plurality of spacers 6 are interspersed in the liquid crystal at this time.

The surface of the side on which the gate electrodes 12 are formed in the TFT substrate 2 is then turned towards the surface of the side on which the color filter is formed in the CF substrate 3, the TFT substrate 2 is aligned with respect to the CF substrate 3 so that the gate electrodes 12 are superposed on the black matrix 22 as viewed from above, and the TFT substrate 2 is bonded to the CF substrate 3 via the seal member 4 and liquid crystal. The liquid crystal layer 5 is thereby positioned in the space enclosed by the TFT substrate 2, the CF substrate 3, and the seal member 4.

The substrates are aligned by a process in which the automatic matching measurement system emits white light to the CF substrate 3, receives reflected light, acquires an image of the CF substrate 3, and detects the alignment mark 31 by digitizing this image. Since debris 41 is not present at this time in the region adjacent to the alignment mark 31, the automatic matching measurement system can detect the alignment mark 31 with good precision.

The optical waveguide 20 is then affixed to the surface of the side not facing the CF substrate 3 in the transparent substrate 11 of the TFT substrate 2, and the optical waveguide 28 is affixed to the surface of the side not facing the TFT substrate 2 in the transparent substrate 21 of the CF substrate 3. The LCD panel 1 is thereby manufactured.

According to the present embodiment, debris 41 is not deposited in the region adjacent to the alignment mark 31 during the rubbing step, making it possible for the automatic matching measurement system to detect the alignment mark 31 with high precision during the step in which the TFT substrate 2 is bonded to the CF substrate 3. The TFT substrate 2 and the CF substrate 3 can thereby be efficiently and reliably aligned with each other. As a result, light leakage and deterioration of the characteristics of the semiconductor layer due to light exposure can be reliably prevented.

The step for forming the black matrix 22 and the blue color filter 25 can also be used to form the alignment mark 31 and the trapping pattern 32. Therefore, there is no need to provide a special step for forming the trapping pattern 32, and the manufacturing cost can be reduced.

In the present embodiment, an example is described in which the red color filter, the green color filter, and the blue color filter are formed in this sequence in the step for creating the CF substrate 3, but the sequence in which the color filters are formed is not particularly limited in the present invention. The upper layer of the trapping pattern 32 may also be formed in the step for forming the red color filter 23, or in the step for forming the green color filter 24.

In the present embodiment, an example is described in which the alignment mark 31 is rectangular as viewed from above, but the shape of the alignment mark is determined by the specifications of the automatic matching measurement system, and may be a round shape, a dot-type shape, or another non-rectangular shape.

A modification of the fourth embodiment will next be described. As shown in FIG. 8, in the present modification, a pattern is formed in a black-colored resin layer applied on the transparent substrate 21 of the CF substrate 3, and the lower layer of the trapping pattern is shaped as a frame so as to surround the alignment mark 31 in the step for forming the black matrix 22, the alignment mark 31 and the lower layer of the trapping pattern. A pattern is then formed in the blue-colored transparent resin layer, and a frame-shaped upper layer is formed directly above the lower layer of the trapping pattern in the step for forming the blue color filter 25 and the upper layer of the trapping pattern. A frame-shaped trapping pattern 33 that surrounds the alignment mark 31 is thereby formed. According to the present modification, debris 41 can be prevented from accumulating around the alignment mark 31 regardless of the rubbing direction. Configurations, operations, and effects other than those described above in the present modification are the same as in the previously described fourth embodiment.

A fifth embodiment of the present invention will next be described. The present embodiment is an embodiment of the method for manufacturing the color LCD panel according to the previously described second embodiment. In the present embodiment, after the black-colored resin layer is applied in the step for creating the CF substrate, the black-colored resin layer is allowed to remain only in the region in which the black matrix and the alignment mark are to be formed in the step for performing exposure, development, and patterning. This black-colored resin layer is then baked in a first stage at low temperature for a short time, and in a second stage at high temperature for a long time conducted in succession, rather than under standard conditions such as in the previously described fourth embodiment. These standard conditions included a temperature of 230° C. and a time of 60 minutes, for example. The conditions in the first stage are a temperature of 120° C. and a time of 10 minutes, and the conditions in the second stage are a temperature of 230° C. and a time of 40 minutes, for example. An alignment mark 34 can thereby be formed that has a taper angle 6 of 30 to 60 degrees (45 degrees, for example), as shown in FIGS. 9A and 9B. In the step for patterning the blue-colored transparent resin layer, the blue-colored transparent resin layer is allowed to remain only in the region in which the blue color filter 25 is to be formed. As a result, a trapping pattern is not formed in the present embodiment. Aspects of the configuration of the present embodiment other than those described above are the same as in the previously described fourth embodiment. Specifically, the method for creating the TFT substrate and the method for bonding the TFT substrate with the CF substrate, for example, are the same as in the fourth embodiment.

By giving the alignment mark a taper angle of 30 to 60 degrees (45 degrees, for example) in the step for forming the black matrix and the alignment mark according to the present embodiment, debris from the alignment layer is less likely to be trapped at the edge of the alignment mark when the alignment layer of the CF substrate is subjected to the rubbing treatment. The automatic matching measurement system can thereby detect the alignment mark with high precision in the step for bonding the TFT substrate with the CF substrate. Operations and effects in the present embodiment other than those described above are the same as in the previously described fourth embodiment.

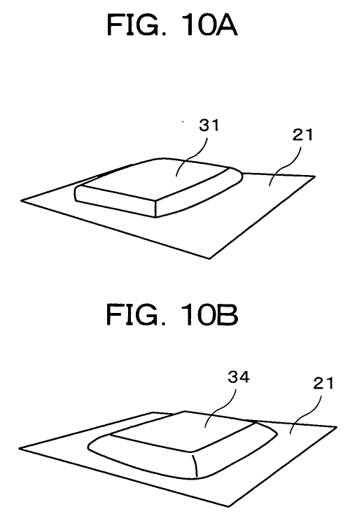

The actual results of forming the alignment mark under the abovementioned baking conditions will be described hereinafter. FIGS. 10A and 10B are tracings of SEM (Scanning Electron Microscopy) photographs showing the alignment mark. FIG. 10A shows the effects of baking under the conditions described in the aforementioned fourth embodiment, i.e., a temperature of 230° C. and a time of 60 minutes. FIG. 10B shows the effects of baking under the conditions described in the present fifth embodiment, i.e., a first stage for baking at a temperature of 120° C. for 10 minutes, and a subsequent second stage for baking at a temperature of 230° C. for 40 minutes.

As shown in FIG. 10B, the alignment mark 34 in which the black-colored resin material is baked under the conditions (two-stage baking conditions) of the present embodiment has a taper angle of approximately 45 degrees, and has a lateral face that is more gently sloped in comparison to the alignment mark 31 shown in FIG. 10A formed according to the conditions (single-stage baking conditions) of the fourth embodiment. An alignment mark in the shape of a square truncated pyramid having a taper angle of 30 to 60 degrees can thus be formed according to the present embodiment.

A sixth embodiment of the present invention will next be described. The present embodiment is an embodiment of the method for manufacturing the LCD panel according to the previously described third embodiment. In the present embodiment, after the black-colored resin layer is applied in the step for creating the CF substrate, the black-colored resin layer is allowed to remain only in the region in which the black matrix and the alignment mark are to be formed in the step for performing exposure, development, and patterning. This black-colored resin layer is then baked under the same conditions as in the aforementioned fourth embodiment. Baking is performed at a temperature of 230° C. for 60 minutes, for example. In the step for patterning the blue-colored transparent resin layer, this blue-colored transparent resin layer is allowed to remain only in the region in which the blue color filter 25 is to be formed. As a result, a trapping pattern is not formed in the present embodiment. Furthermore, when the alignment layer 27 (see FIG. 2) is formed, the alignment layer 27 is formed so as to be large enough to cover the alignment mark 31. For example, the region in which the alignment layer 27 is formed is extended about 1 to 2 mm outward compared to the aforementioned fourth embodiment. Aspects of the configuration of the present embodiment other than those described above are the same as in the previously described fourth embodiment.

In the present embodiment, the stepped portion at the edge of the alignment mark 31 can be gently sloped by covering the alignment mark 31 with the alignment layer 27. This makes it possible to prevent debris from the alignment layer from being trapped in the stepped portion of the alignment mark when the alignment layer is subjected to a rubbing treatment. Alignment recognition errors are therefore less likely to occur in the automatic matching measurement system.

What is claimed is:

1. A liquid crystal display comprising:
a first substrate;
a second substrate disposed facing the first substrate; and
a liquid crystal layer disposed between said first substrate and said second substrate; wherein
said first substrate has an alignment mark for performing alignment with respect to said second substrate; and
debris from the alignment layer is not deposited in the region adjacent to said alignment mark.

2. A liquid crystal display comprising:
a first substrate;
a second substrate disposed facing the first substrate; and
a liquid crystal layer disposed between said first substrate and said second substrate, wherein said first substrate comprises:
an insulating substrate;
an alignment layer imparting a pre-tilt angle to the liquid crystal molecules of said liquid crystal layer and being provided on the insulating substrate;
an alignment mark by which alignment is performed with respect to said second substrate and which is provided on said insulating substrate; and
a trapping pattern having greater step than the step of said alignment mark and being provided in a position, at least upstream in the rubbing direction of said alignment layer.

3. The liquid crystal display according to claim 2, wherein
said insulating substrate is a transparent substrate;
said first substrate furthermore has a black matrix and a color filter; and
said trapping pattern has a lower layer formed from the same material as the material for forming said black matrix, and an upper layer provided on the lower layer and formed from the same material as the material for forming said color filter.

4. The liquid crystal display according to claim 3, wherein said alignment mark is formed from the same material as the material for forming said black matrix.

5. The liquid crystal display according to claim 2, wherein said trapping pattern is L-shaped as viewed from the surface of said insulating substrate.

6. The liquid crystal display according to claim 2, wherein said trapping pattern is in the shape of a frame that surrounds said alignment mark as viewed from the surface of said insulating substrate.

7. A liquid crystal display comprising:
a first substrate;
a second substrate disposed facing the first substrate; and
a liquid crystal layer disposed between said first substrate and said second substrate;
wherein said first substrate has
an insulating substrate;
an alignment layer provided on the insulating substrate and imparting a pre-tilt angle to the liquid crystal molecules of said liquid crystal layer; and
an alignment mark provided on said insulating substrate and by which alignment is performed with respect to said second substrate; and
the angle between the surface of said insulating substrate and the lateral surface of said alignment mark is 30 to 60 degrees.

8. A liquid crystal display comprising:
a first substrate;
a second substrate disposed facing the first substrate; and
a liquid crystal layer disposed between said first substrate and said second substrate;
wherein said first substrate comprises;
an insulating substrate;
an alignment layer provided on the insulating substrate and imparting a pre-tilt angle to the liquid crystal molecules of said liquid crystal layer; and
an alignment mark provided on said insulating substrate and by which alignment is performed with respect to said second substrate; and
said alignment mark is covered by said alignment layer.

9. A method for manufacturing a liquid crystal display, comprising the steps of:
bonding a first substrate and a second substrate together;
inserting a liquid crystal layer between said substrates;
further comprising the steps of:
forming an alignment mark and a trapping pattern on an insulating substrate, whose step is greater than the step of said alignment mark;
forming an alignment layer for imparting a pre-tilt angle to the liquid crystal molecules of said liquid crystal layer on said insulating substrate; and
performing a rubbing treatment on said alignment layer in the direction from said trapping pattern to said alignment mark; and
said bonding is performed by using said alignment mark.

10. The method for manufacturing a liquid crystal display according to claim 9, wherein said forming of an alignment mark and a trapping pattern comprises the steps of:
forming an opaque resin layer;
patterning and baking the resin layer to form a black matrix, the lower layer of said alignment mark and the lower layer of said trapping pattern;
forming a colored transparent resin layer; and
patterning the transparent resin layer and forming the upper layer of said trapping pattern and a color filter.

11. A method for manufacturing a liquid crystal display, comprising the steps of:
bonding a first substrate and a second substrate together;
inserting a liquid crystal layer between said substrates;
further comprising the steps of:
forming an opaque resin layer on an insulating substrate;
patterning the resin layer;
heating said patterned resin layer at a first temperature for a first period;
baking said resin layer for a second period longer than said first period and at a second temperature higher than said first temperature, and forming an alignment mark having lateral surface whose angle is 30 to 60 degrees with respect to the surface of said insulating substrate;
forming an alignment layer to impart a pre-tilt angle to the liquid crystal molecules of said liquid crystal layer on said insulating substrate; and
performing a rubbing treatment on said alignment layer; and
wherein said bonding is performed by using said alignment mark.

12. A method for manufacturing a liquid crystal display, comprising the steps of:
bonding a first substrate and a second substrate together;
inserting a liquid crystal layer between said substrates;
further comprising the steps of:
forming an alignment mark on an insulating substrate; forming an alignment layer to impart a pre-tilt angle to the liquid crystal molecules of said liquid crystal layer on said insulating substrate so as to cover said alignment mark; and
performing a rubbing treatment on said alignment layer; and wherein-said bonding is performed by using said alignment mark.
